(19) United States
(12) Patent Application Publication
(10) Pub. No.: US 2005/0109840 A1
(43) Pub. Date: May 26, 2005

(54) System and method for charitable organization-branded marketing

(76) Inventors: James P. Walker JR., Dallas, TX (US); Michael A. Jacobson, Dallas, TX (US)

Correspondence Address: FISH & RICHARDSON P.C., 5000 BANK ONE CENTER, 1717 MAIN STREET, DALLAS, TX, 75201, US

(21) Appl. No.: 10/970,838

(22) Filed: Oct. 21, 2004

Related U.S. Application Data
(60) Provisional application No. 60/513,906, filed on Oct. 23, 2003.

(51) Int. Cl. G06K 5/00; G06F 17/60

(52) U.S. Cl. 235/380; 705/14

(57) ABSTRACT

Implementations of a method for associating a charitable donation with a discounted transaction include, providing a certificate asociated with a discount for at least one vendor to a customer, receiving notification of a discounted transaction using the certificate, and determining a charitable donation associated with the discounted transaction. In other implementations, a method for associating a charitable donation with a discounted transaction includes generating certificates associated with a vendor. The certificates have a face value usable in exchanges with the vendor. The method further includes selling the certificates to at least one customer at a price less than the face value. The method also includes determining a charitable donation associated with the sale of each certificate based at least in part on either the face value of the certificate sold or the price of the certificate sold. Implementations of a system for associating a charitable donation with a discounted transaction include an intermediary providing certificates to customers.

### TECHNICAL FIELD

This invention relates to associating charitable donations with business transactions, and more particularly to associating a charitable donation with a discounted transaction.

### BACKGROUND

The efficient acquisition of new customers, as well as the retention of existing customers, are a dominant concern for virtually all providers of goods and services. Traditional advertising of goods and services is often employed in an effort to generate new customers and retain current ones. Over time, potential customers become jaded and even “numb” to traditional advertising for a number of reasons. Reasons that potential customers become desensitized to traditional advertising include the proliferation of advertising from a variety of sources and the use of copycat ads that mimic one another.

Not-for-profit and other charitable organizations struggle with efficient fundraising. Every dollar spent to raise money for the charity cannot be used to advance the mission or cause of the charity. Due to an overarching need to keep overhead expenses to a minimum, many charitable organizations have been unable to take advantage of newer technologies for the purposes of fundraising because to do so would require an investment in information technology and its infrastructure. As a result, charitable organizations typically employ traditional methods of fundraising, relying on corporate sponsors for a large part of their capital. Their use of traditional methods and media for fundraising present them with the same advertising fatigue syndrome as the providers of goods and services experience. A related phenomenon is that individuals generally desire to contribute to charitable causes and organizations, often citing the lack of ease of doing so as a main impediment to making more contributions.

### SUMMARY

Implementations of a method for associating a charitable donation with a discounted transaction include, providing a certificate asociated with a discount for at least one vendor to a customer, receiving notification of a discounted transaction using the certificate, and determining a charitable donation associated with the discounted transaction. In other implementations, a method for associating a charitable donation with a discounted transaction includes generating certificates associated with a vendor. The certificates have a face value usable in exchanges with the vendor. The method further includes selling the certificates to at least one customer at a price less than the face value. The method also includes determining a charitable donation associated with the sale of each certificate based at least in part on either the face value of the certificate sold or the price of the certificate sold. Implementations of a system for associating a charitable donation with a discounted transaction include an intermediary providing certificates to customers. Each of the certificates is associated with a discount provided by at least one vendor. The vendor or vendors receive certificates from the customer and provide notification to the intermediary of discounted transactions using the certificates. The intermediary determines a charitable donation associated with each of the discounted transactions.

Various implementations may include one or more of the following features. Certificates may be in the form of magnetically encoded cards or debit cards, and may be marked with indicia associated with a charitable organzation receiving the charitable donation. A balance associated with a certificate may be adjusted when a transaction is made. Transaction information associated with the discounted transactions may be stored in a database, which may in turn be made accessible using a website.

In addition to those features, various implementations of these methods may include purchasing advertising space and selling at least a portion of the advertising space to a vendor in exchange for certificates. Such methods may also include receiving compensation from the customers for the certificates and allocating a portion of the received compensation to the charitable organization. A portion of the received compensation may also be allocated to the vendor.

Using particular implementations of the invention, providers of goods and services can acquire new customers, and retain existing ones, via advertising that includes the branding of one or more charitable organizations. Likewise, charitable organizations can piggy-back on the technological advances offered through the techniques of the present invention, efficiently increasing their fundraising without the need to invest precious resources in information technology and its infrastructure. Finally, consumers of goods and services can purchase items and utilize services they otherwise already consume, but perceive an added value to the transaction because part of the transaction amount is designated for charity. That the consumer can designate just which charity receives benefit from the purchase of goods and services by that consumer is an additional feature of certain implementations of the present invention.

The details of one or more embodiments of the invention are set forth in the description, figures, and claims provided herein. Other features, objects, and advantages of the invention will be apparent from the description, figures, and claims.

### BRIEF DESCRIPTION OF THE DRAWINGS

FIG. 1 is a block diagram illustrating an economic system for associating a charitable donation with a discounted transaction;

FIG. 2 is a block diagram of a system for managing discounted transactions associated with charitable donations and maintaining records thereof; and

FIG. 3 is a flow diagram of a process for associating a charitable donation with a discounted transaction.

### DETAILED DESCRIPTION

FIG. 1 depicts an economic system 100 that includes vendors 102 providing goods and/or services to customers 104. “Vendor” may refer to any individual or organization providing any type of good or service for purchase by customers. System 100 also includes advertisers 106 that provide information to customers 104 about vendors 102 to entice customers 104 to purchase goods and/or services from particular vendors 102. Advertisers 106 may include any organization that provides such information to customers 104 using any appropriate medium of communication, including such forms as print media, broadcast media, in-person solicitation, and telemarketing. The term “advertising space” as used below will refer to any corresponding unit of advertising appropriate to the medium, such as, for example, classified ads in newspapers or airtime on a radio network. In addition, system 100 includes charitable organizations 108. Charitable organizations 108 may include any individual or organization that collects donations for any purpose, which may include (but are not limited to) traditional charities as well as other non-profit organizations.

System 100 also includes an intermediary 110. Intermediary 110 is an organization that facilitates donations from customers 104 to charitable organizations 108 by providing certificates 112 to customers 104. Certificates 112 are any medium of exchange accepted by one or more vendors 102 such that the value of each certificate 112 in exchange for goods and/or services is greater than the purchase price of the certificate 112. For example, one type of certificate 112 with an exchange value of $100 when used at a particular vendor 104 could be purchased for $70 or some other amount less than $100. Certificates 112 may take any tangible or intangible form, including paper certificates, magnetically encoded cards, debit accounts, credit cards, or any other similar method of accounting for exchanges. In other implementations, charitable organization 108 may provide certificates 112 to customers 104 directly without using an intermediary, so it should be understood that the system and techniques described below may be suitably adapted to function without an intermediary.

Overall, system 100 allows a donation to one or more of the charitable organizations 108 to be associated with a discounted transaction between customers 104 and vendors 102. This provides incentives, in the form of discounts, for customers 104 to engage in transactions with vendors 102. Furthermore, the association of charitable organizations 108 with the transactions not only provides customers 104 wishing to support a charity with additional incentives to engage in such transactions but also provides a relatively easy way for charitable organizations 108 to receive donations from customers 104. The use of various marketing strategies leveraging the logos, marks, or other branding indicia of charitable organizations 108 in conjunction with similar indicia of vendors 102 may also provide additional ways to utilize the association between vendors 102 and charitable organizations 108. A provider of goods and/or services may increase the sales of such goods and/or services by offering its goods and/or services in connection with the brands of charitable organizations. The use of such brands, coupled with the general desire by potential consumers to contribute to charities, receive a discount for purchases of goods and/or services, and designate the recipient charitable organization associated with the transaction, works to produce increased sales.

The arrows in FIG. 1 illustrate one example of a discounted transaction associated with charitable donations. In the depicted example, intermediary 110 manages an exchange of discount certificates 112 between vendors 102 and customers 104. The process takes place as follows. Vendors 102 provide discount certificates 112 to intermediary 110, which are sold by intermediary 110 to customers 104. In exchange for discount certificates. 112 received from vendors 102, intermediary 110 coordinates an advertising campaign in which vendor brands 113 are advertised in conjunction with shared brands 118 provided by charitable organizations 108. As part of the advertising campaign, both advertisers 106 and intermediary 110 may provide co-branded advertisements 116 to customers 102. The co-branded advertisements 116 inform customers 102 that discount certificates 112 for vendors 102 are available for purchase and that a portion of the proceeds from the sale of certificates 112 will be donated to charitable organizations 108.

Customers 102, attracted by the prospect of receiving discounts while conveniently donating to charities 108, purchase certificates 112 from intermediary 110. The payments from customers 102 are used in part to fund donations 114 to charitable organizations 108 that made shared brands 118 available, so that donations 114 are associated with providing discounts to customers 102. Each customer 102 purchasing certificates 112 may be allowed to designate which of the charitable organizations 108 will receive donations 114 associated with his purchase. Customers 104 then use certificates 112 to obtain discounts 120 from vendors 102.

The described techniques for associating a discount with a donation to a charitable organization may be applied to any manner of business involving the exchange or sale of goods and/or services. Some examples of such businesses include retail stores, restaurants, travel agencies (including sales of vacation packages and similar travel consolidation services), and telecom vendors (including prepaid telephone cards as well as incentive programs for switching to a telecom provider). In principle, however, there is no limit to the types of business to which the techniques may be applied.

In an example implementation, intermediary 110 brokers advertising space from advertisers 106 to develop an inventory of certificates 112. Intermediary 110 negotiates to obtain space from advertiser 106, possibly at a discount (e.g., at a not-for-profit or bulk rate based on the relationship between intermediary 110 and charitable organizations 108). In this negotiation, advertiser 106 agrees to allow intermediary 110 to subdivide the purchased advertising space among several vendors 104. Intermediary 110 then sells portions of the advertising space to vendors 104 at a certain price, with vendors 104 paying for at least a portion of the advertising space with certificates 112. Vendors 104 agrees to provide goods and/or services equivalent to the face value on each certificate 112 to the holder of that certificate 112. For example, suppose that portions of the advertising space were being sold for $1000 to cover the advertising costs incurred by intermediary 110. A vendor 104 purchasing one of the units could pay $500 in cash and provide $1000 face value in certificates 112. Alternatively, vendor 102 may agree to allow intermediary 110 to sell an unlimited number of discount certificates 112 in exchange for being included in the advertisements and receiving a portion of the total revenue from sales of certificates 112. Intermediary 110 then sells certificates 112 at less than the face value to customers 102, thus providing customers 102 a discounted rate on the goods and/or services provided by vendor 102.

Once the advertising space is sold to vendors 104, intermediary 110 places an advertisement depicting logos or other indicia of vendors 104 that purchased advertising space, as well as a list of names (or other indicia such as logos) of charitable organizations 108 that a purchaser of certificates 112 may designate to receive a donation when certificates 112 are used to purchase goods and/or services. In the advertisement, intermediary 110 offers certificates 112 for sale while supplies last, applying a portion of the discount offered by vendor 104 to discount the price of certificates 112. Certificates 112 may be sold using any suitable vending method, including websites, telephone purchases, in-store purchases, or numerous other sales methods. The price of certificates 112 may be set at any level less than the face value and greater than the cost to acquire certificates 112, including expenses such as advertising. A portion of the net gain resulting from the sale of certificates 112 is donated to a particular charitable organization 108 designated by the purchaser of certificates 112. This amount, along with the discount, The remainder may be retained by intermediary 110, allowing intermediary 110 to cover transaction costs and/or reap a profit from the transaction.

Certificates 112 may be delivered in a customized format to increase attractiveness and/or expedience. For example, certificates 112 may be customized with the logo of charitable organization 108 and/or vendor 102. Certificates may be incorporated into gift packs that provide information such as the recipient's name, the giver's name, the logo of one or more participating vendors 102 and/or charitable organizations 108 to whom donations will be made, a personalized message, or numerous other customized messages. Certificates 112 may also be provided in the form of a magnetically encoded card, allowing transactions to be electronically processed to facilitate use at vendor 104 premises and providing a single easy-to-carry form for multiple certificates 112. Such cards may also be made rechargeable, such as by associating the cards with a customer account, which provides added convenience for future certificate purchases. To prevent fraud, certificates 112 may be associated with a unique identifier, such as a bar code or magnetically coded number. This allows certificates 112 to be cancelled if used, lost, or stolen.

In another example implementation, intermediary 110 negotiates discounts directly with vendors 102. Vendors 102 agree to provide discounts to members of a program offered by intermediary 110. In exchange, intermediary 110 and vendors 102 may engage in various co-branding efforts and/or coordinated advertising to assist vendor 102 in attracting customers 104. For example, vendor 102 may display signs indicating participation in the charitable donation program, have its name included in promotional materials for charitable organizations 108, and have advertisements placed on intermediary 110 materials, such as websites or promotional literature. Depending on the particular arrangement that is negotiated, vendors 102 may agree to provide discounts only up to a certain amount, effectively giving a limited number of certificates 112, or may instead choose to provide the discount to members of the intermediary's program at all times without limiting the amount, so that certificates 112 sold by intermediary 110 may be used any time to obtain the negotiated discount. Again, a portion of the negotiated discount is provided to the purchaser of certificates 112, another portion is allocated to charitable donations, and the remainder may be retained by intermediary 110 to offset costs and/or reap profits on transactions.

Any of the aforementioned types of certificates 112 may be used in conjunction with such an implementation. For example, a type of certificate 112 that may be used for such an implementation is a debit card that draws on a prepaid account. Essentially, this provides the purchaser with a balance that can be used just like an ordinary debit card, but with the advantage that using the card at participating vendors 104 triggers both the discount and the associated charitable donation. Such implementations may be particularly useful in industries with relatively low profit margins, such as grocery stores, that are unable to provide sufficiently deep discounts to justify a certificate sales program. In those cases, the debit card allows the freedom to apply a relatively tiny percentage of transactions, making the load of the discounts tolerable for such low-margin businesses. To provide additional incentives for using the debit card, refilling the card may be billed to a credit card as a purchase from intermediary 110. The result is that the purchaser may use another credit card to refill the prepaid balance to realize benefits associated with buying products with the credit card, such as cash-back bonuses, reward points, or frequent flyer miles. Thus, the purchaser is able to capture the rewards of both the discount program with the associated charitable donation and the credit card rewards program.

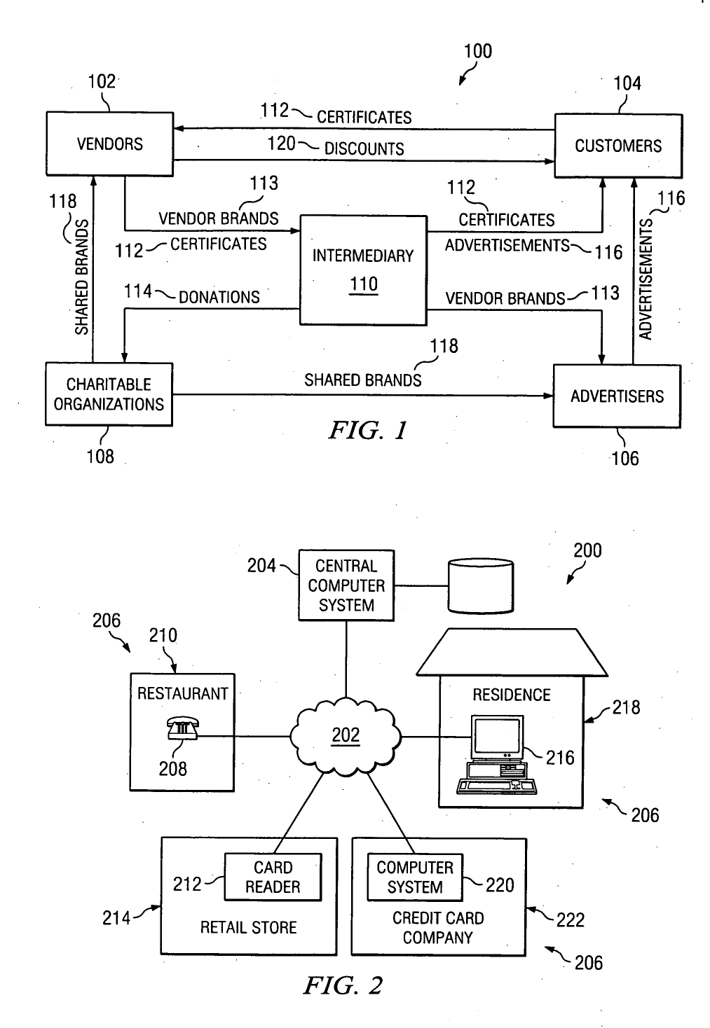

FIG. 2 illustrates an information system 200 that manages transactions associated with charitable donations and collects information associated with those transactions that can be accessed by charitable organizations 108 as well as customers 104. In the depicted implementation, system 200 includes a network 202 allowing intercommunication between a central computer system 204 and various access points 206. Network 202 may include any suitable medium for exchanging information using any communication protocol, including but not limited to the Internet, the public switched telephone network (PSTN), wide area networks (WANs), local area networks (LANs), and other arrangements of hubs, routers, switches, gateways, and/or communication devices. Access points 206 include any manner of device suitable for sending information to network 202 and/or receiving information from network 202. For example, access points 206 may include personal computers (PCs), telephones, credit card readers, computer systems, or numerous other communication devices.

In the depicted example, access points 206 include a telephone 208 located at a restaurant 210, a card reader 212 at a retail store 214, a PC 216 at a residence 218, and a computer system 220 for a credit card company 222. Different access points 206 may be used to perform a variety of functions, described in greater detail as follows. The first function of system 204 is verification and cancellation of certificates. In an example of this function, a customer 104 takes a certificate 112 in the form of a gift certificate to restaurant 210. Service personnel receiving the gift certificate call a toll-free number to access computer system 204 and then enter an identification number on the face of the gift certificate. System 204 accesses a database 224, which may be any form of memory storage capable of maintaining records of certificate information, to verify that the gift certificate is valid. Once all of the value of the gift certificate has been redeemed, system 204 cancels the gift certificate so that it cannot be reused fraudulently by copying or reuse. System 204 may maintain transactions records in database 224 to track when and how certificates 112 are being used. This information may be used to track the contributions to which charitable organizations 108 are entitled.

Another function of system 204 is to process and monitor the use of certificates 112 in the form of debit cards. In an example of this function, customer 104 presents a debit card at retail store 214. A store employee swipes the debit card in card reader 212, which communicates with computer system 220 of credit card company 222 to verify that funds are available. Computer system 220 may in turn communicate with central computer system 204 to confirm that there are sufficient funds in the customer account to cover the transaction. If sufficient funds are available, computer system 220 debits the account, verifies the transaction to the store employee, and records the transaction. Later, central computer system 204 may retrieve this information from credit card computer system 220 to update database 224 with the recent transaction information. This information in turn may be used to track the requisite donations to charitable organizations 108.

The previous functions are examples of how system 204 manages and records transactions. System 204 may also make this information available to vendors 102, customers 104, and charitable organizations 108, allowing them to monitor the effectiveness of the discount program to positively identify the benefits realized. One method of making such information accessible is through the use of a secure, password-protected website, although any of numerous methods of accessing system 204, such as touch-tone telephone access or email requests, may be employed. In an example of website access, a customer 104 may use PC 216 to access system 204 from the customer's residence 218. In addition to allowing services such as purchasing and refilling certificates 112, the website may allow customers 104 to track their total charitable contributions (which may be particularly useful for capturing tax benefits), change the charitable organization (or organizations) 108 that are receiving donations from transactions, and perform numerous other services related to the management of a customer account. System 204 may also use techniques such as email notification to make customers 104 aware both of the savings they have received and the donations they have made.

Similarly, system 204 may provide access to vendors 102 and charitable organizations 108 regarding transactions. For example, system 204 may track the number of transactions for vendors 102, the number of purchased certificates 112, the amount of usage of click-through ads on the intermediary's website, and any other information useful for vendor 102. For charitable organizations 108, system 204 may provide information on total accumulated contributions as well as patterns of usage, such as identifying particular vendors 102 that donors to a particular charitable organization 108 frequent. In such transactions, it may be desirable or necessary to protect customers 104 private or personally identifiable information, so that customers 104 do not have negative experiences with the discount program due to unwanted solicitation by vendors 102 or charitable organizations 108.

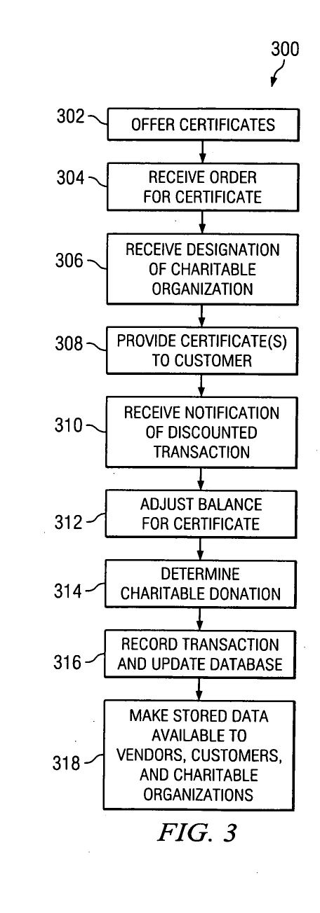

FIG. 3 shows an example method 300 for associating a charitable donation with a transaction. At step 302, intermediary 110 offers for sale one or more forms of certificates 112 associated with discounts at vendors. Certificates 112 may take any suitable form, including any of the forms described above such as gift certificates, magnetic cards, or debit accounts. Intermediary 110 receives an order from a customer 104 at step 304. Orders may be received in any suitable manner, including such implementations as receiving orders over the Internet using a website. Intermediary 110 receives a designation of a charitable organization 108 from the customer 104 at step 306. Note that it is not a requirement that there be multiple charitable organizations 108 associated with the discount program, but if multiple charitable organizations 108 are available, intermediary 110 may allow selection of one or more of the available organizations 108. Intermediary 110 then provides certificates, preferably associated with a unique identifier allowing the use of certificates 112 to be tracked, to customer 104 at step 308.

Intermediary 110 receives notification of a discounted transaction using certificates 112 at step 310. At step 312, intermediary 110 adjusts a balance associated with used certificates 112 at step 312, which helps to prevent certificates 112 from being used fraudulently. Intermediary 110 determines a charitable donation associated with the transaction at step 314 and stores data associated with the transaction, such as information identifying the vendor receiving the certificate, the recipient and amount of the charitable donation, or numerous other types of information, at step 316. Intermediary 110 may also make stored transaction data available to vendors 102, customers 104, and/or charitable organizations 108 at step 318.

Although a particular example method has been described, it should be understood that numerous other methods for associating charitable donations with discount transactions. In particular, any method consistent with any of the implementations described above may be used. Furthermore, various steps of the method may be performed in a different order, particular steps of the method may be omitted, and additional steps may be included in a manner consistent with any of the implementations described herein.

Advantages of particular implementations are numerous and varied. One advantage of some implementations is that the techniques for associating charitable donations with discounted transactions are scalable. Such implementations may be extended to more vendors 104, charitable organizations 108, and transactions without substantially altering the method of operation. Another advantage of particular implementations is allowing charitable organizations 108 to efficiently increase its fundraising without increasing its overhead. Such an advantage may be realized by making it easier for individuals to contribute to charitable organization of their selection by engaging in activities that are already part of a customer's ordinary routine. Additional benefits may be realized by enabling the charitable organization to use the technological infrastructure of intermediary 110 to reach new potential donors, and retain existing ones, without having to invest in information technology or similar infrastructure. Intermediaries 110 may also realize advantages associated with particular implementations. For example, intermediary 110 may be able to make a profit without carrying an inventory of products or undertaking any overhead associated with the traditional offering of goods and/or services. Particular implementations may afford some, none, or all of the enumerated advantages.

A number of embodiments of the invention have been described. Nevertheless, it will be understood that various modifications may be made without departing from the spirit and scope of the invention. For example, other systems capable of performing described functions are contemplated by the techniques of the present invention. Accordingly, other embodiments are within the scope of the following claims.

1. A method for associating a charitable donation with a discounted transaction, comprising:
providing a certificate to a customer, wherein the certificate is associated with a discount for at least one vendor;
receiving notification of a discounted transaction using the certificate; and
determining a charitable donation associated with the discounted transaction.

2. The method of claim 1, wherein the certificate comprises a magnetically encoded card.

3. The method of claim 1, wherein the certificate comprises a debit card.

4. The method of claim 1, further comprising storing transaction information associated with the discounted transaction in a database.

5. The method of claim 4, further comprising making the transaction information in the database accessible by a website.

6. The method of claim 1, further comprising adjusting a balance associated with the certificate when the notification is received.

7. The method of claim 1, further comprising:
purchasing advertising space; and
selling at least a portion of the advertising space to the vendor in exchange for certificates associated with a discount.

8. The method of claim 1, wherein the certificate is marked with indicia associated with a charitable organization receiving the charitable donation.

9. The method of claim 1, further comprising receiving compensation for the certificate from the customer, wherein the step of determining the charitable donation comprises allocating a portion of the received compensation to the charitable donation.

10. The method of claim 9, further comprising allocating another portion of the received compensation to the vendor.

11. A system for associating a charitable donation with a discounted transaction, comprising:
a certificate associated with a discount provided by a vendor; and
a computer system operable to perform the steps of:
receiving notification of a discounted transaction using the certificate; and
determining a charitable donation associated with the discounted transaction.

12. The system of claim 9, wherein the certificate comprises a magnetically encoded card.

13. The system of claim 9, wherein the certificate comprises a debit card.

14. The system of claim 9, wherein the computer system is further operable to store transaction information associated with the discounted transaction in a database.

15. The system of claim 12, wherein the computer system is further operable to make the transaction information in the database accessible by a website.

16. The system of claim 9, wherein the computer system is further operable to update a balance associated with the certificate when the notification is received.

17. The system of claim 9, wherein the certificate is marked with indicia associated with a charitable organization receiving the charitable donation.

18. The system of claim 9, wherein the computer system receives compensation for the certificate from the customer, and determines the charitable donation by allocating a portion of the received compensation to the charitable donation.

19. The system of claim 16, wherein the computer system allocates another portion of the received compensation to the vendor.

20. A system for associating a charitable donation with a discounted transaction, comprising:
an intermediary providing certificates to customers, wherein each of the certificates is associated with a discount provided by at least one vendor; and
the at least one vendor receiving certificates from the customer and providing notification to the intermediary of discounted transactions using the certificates, wherein the intermediary determines a charitable donation associated with each of the discounted transactions.

21. The system of claim 20, further comprising an advertiser and wherein the intermediary provides advertising space from the advertiser to the at least one vendor in exchange for the certificates.

22. The system of claim 20, further comprising a database storing transaction information for the discounted transactions.

23. The system of claim 22, wherein the transaction information is made available using a website.

24. The system of claim 20, wherein the certificates comprise magnetically encoded cards.

25. The system of claim 20, wherein the certificates comprise debit cards.

26. The system of claim 20, wherein the certificates are marked with indicia associated with a charitable organization receiving the charitable donation.

27. A method for associating a charitable donation with a discounted transaction, comprising:
generating certificates associated with a vendor, the certificates comprising a face value usable in exchanges with the vendor;
selling the certificates to at least one customer, wherein each certificate is sold at a price less than the face value; and
determining a charitable donation associated with the sale of each certificate based at least in part on one of the face value of the certificate sold or the price of the certificate sold.

28. The method of claim 27, further comprising providing advertising using the brand of the vendor and a brand of at least one charitable organization receiving at least one of the charitable donations.

29. The method of claim 28, wherein the advertising comprises an advertising space and the certificates are received as part of a payment for a portion of the advertising space.

30. The method of claim 27, further comprising determining a portion of proceeds from the sale of the certificates based at least in part on a total face value of the certificates sold, and paying the portion of the proceeds to the vendor.

31. The method of claim 27, wherein the certificates comprise magnetically encoded cards.
